(19) United States
(12) Patent Application Publication
(10) Pub. No.: US 2012/0112587 A1
(43) Pub. Date: May 10, 2012

(54) Hydrodynamic bearing assembly and motor including the same

(75) Inventor: Duc Kyoung Kim, Suwon (KR)

(73) Assignee: SAMSUNG ELECTRO-MECHANICS CO., LTD, Suwon (KR)

(21) Appl. No.: 13/064,591

(22) Filed: Apr. 1, 2011

(30) Foreign Application Priority Data
Nov. 4, 2010 (KR) 10-2010-0109308

(51) Int. Cl. F16C 32/06; H02K 7/08

(52) U.S. Cl. 310/90; 384/114; 384/107

(57) ABSTRACT

Disclosed is a hydrodynamic bearing assembly including: a rotary member fixed to a shaft and rotating in linkage with the shaft; and a sleeve supporting the shaft, wherein a coating film is formed by spraying, at high pressure, a solid lubricant having a single component onto one surface of at least one of the sleeve and the rotary member corresponding to the sleeve.

### CROSS-REFERENCE TO RELATED APPLICATIONS

This application claims the priority of Korean Patent Application No. 10-2010-0109308 filed on Nov. 4, 2010, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same, and more particularly, to a hydrodynamic bearing assembly having enhanced stability by improving the lubricity and abrasion resistance thereof, and a motor including the same.

2. Description of the Related Art

A hard disk drive (HDD), an information storage device, reproduces data stored on a disk or records data on the disk by using a read/write head.

The HDD requires a disk driver capable of driving the disk and a small-sized spindle motor is used as the disk driver.

As the small-sized spindle motor, a hydrodynamic bearing assembly is used. In the hydrodynamic bearing assembly, oil is interposed between a shaft, which is a rotary member, and a sleeve, which is a stationary member, such that fluid pressure generated by the oil supports the shaft.

Since the spindle motor has a structure, in which a rotary member and a stationary member are provided, and the rotary member rotates around the stationary member, friction is inevitably generated and a friction portion is abraded.

The degree of abrasion in the friction portion is closely associated with the stability, performance, and lifespan of the spindle motor and, in the related art, a coating film is formed by applying a lubricant to the friction portion or using a composite material.

However, according to the related art, after the application of the lubricant, a previously designed size is changed, such that a processing operation is necessarily performed.

Further, in the processing operation, a considerable number of spindle motor portions may be discarded in order to precisely adjust the size of the spindle motor.

Accordingly, research into improving abrasion resistance and stability, by reducing friction in the spindle motor, is urgently required.

### SUMMARY OF THE INVENTION

An aspect of the present invention provides a hydrodynamic bearing assembly having improved abrasion resistance by minimizing friction between a rotary member and a stationary member and achieving enhanced stability by increasing the rigidity of a friction portion, and a motor including the same.

According to an aspect of the present invention, there is provided a hydrodynamic bearing assembly including: a rotary member fixed to a shaft and rotating in linkage with the shaft; and a sleeve supporting the shaft, wherein a coating film is formed by spraying, at high pressure, a solid lubricant having a single component onto one surface of at least one of the sleeve and the rotary member corresponding to the sleeve.

The solid lubricant may be formed of particles having an ultrafine size.

A microdimple may be formed in one surface of the sleeve or of the rotary member corresponding to the sleeve onto which the solid lubricant is sprayed at high pressure.

The microdimple may be an oil storage space positioned between the sleeve and the rotary member.

The solid lubricant may be at least one of a fluorine resin, graphite, and molybdenum disulfide.

The sleeve or the rotary member corresponding to the sleeve, onto which the solid lubricant is sprayed at high pressure, is coupled to the solid lubricant, and as the solid lubricant infiltrates and moves inwards, a content thereof may decrease.

According to another aspect of the present invention, there is provided a hydrodynamic bearing assembly including: a rotary member fixed to a shaft and rotating in linkage with the shaft; a sleeve supporting the shaft; and a thrust plate disposed in at least one of upper and lower portions of the shaft in an axial direction thereof, coupled to the shaft, and providing thrust dynamic pressure, wherein a coating film is formed by spraying, at high pressure, a solid lubricant having a single component onto one surface of at least one of the thrust plate, the sleeve and the rotary member corresponding to the thrust plate.

The solid lubricant may be formed of particles having an ultrafine size.

A microdimple may be formed in one surface of the sleeve or of the rotary member corresponding to the sleeve, onto which the solid lubricant is sprayed at high pressure.

The microdimple may be an oil storage space positioned between the sleeve and the rotary member.

The solid lubricant may be at least one of a fluorine resin, graphite, and molybdenum disulfide.

The sleeve or the rotary member corresponding to the sleeve, onto which the solid lubricant is sprayed at high pressure, is coupled to the solid lubricant, and as the solid lubricant infiltrates and moves inwards, a content thereof may decrease.

The hydrodynamic bearing assembly may further include a cap member coupled to the sleeve on an upper portion of the thrust plate such that oil may be sealed between the thrust plate and the cap member, wherein the thrust plate is positioned on the upper portion of the shaft in the axial direction.

A coating film may be formed on one surface of the cap member corresponding to the thrust plate by spraying a solid lubricant having a single component thereon at high pressure.

According to another aspect of the present invention, there is provided a motor including: the hydrodynamic bearing assembly as described above; and a stator coupled to an outer circumferential surface of the sleeve and including a core on which a coil for generating a rotational driving force due to interaction with a magnet coupled to one surface of the rotary member is wound.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a hydrodynamic bearing assembly according to a first exemplary embodiment of the present invention;

FIG. 2 is a schematic cut-away perspective view showing a case in which a solid lubricant is sprayed onto a surface of a rotor case at high pressure, the rotor case provided to the hydrodynamic bearing assembly according to the first exemplary embodiment of the present invention;

FIG. 3 is a schematic perspective view showing a case in which a solid lubricant is sprayed onto a thrust plate at high pressure, the thrust plate provided to the hydrodynamic bearing assembly according to the first exemplary embodiment of the present invention;

FIG. 4 is a schematic cross-sectional view showing a motor including a hydrodynamic bearing assembly according to a second exemplary embodiment of the present invention;

FIG. 5 is a schematic perspective view showing a case in which a solid lubricant is sprayed onto a thrust plate at high pressure, the thrust plate provided to the hydrodynamic bearing assembly according to the second exemplary embodiment of the present invention;

FIG. 6 is a schematic cross-sectional view showing a motor including a hydrodynamic bearing assembly according to a third exemplary embodiment of the present invention;

FIG. 7 is a schematic cross-sectional view showing a motor including a hydrodynamic bearing assembly according to a fourth exemplary embodiment of the present invention; and

FIG. 8 is a schematic cut-away perspective view showing a case in which a solid lubricant is sprayed onto a cap member at high pressure, the cap member provided to the hydrodynamic bearing assembly according to the fourth exemplary embodiment of the present invention.

### DETAILED DESCRIPTION OF THE PREFERRED EMBODIMENT

Exemplary embodiments of the present invention will now be described in detail with reference to the accompanying drawings.

The present invention is not limited to the exemplary embodiments and the exemplary embodiments are used to help understanding the spirit of the present invention. Like reference numerals refer to like elements in the accompanying drawings.

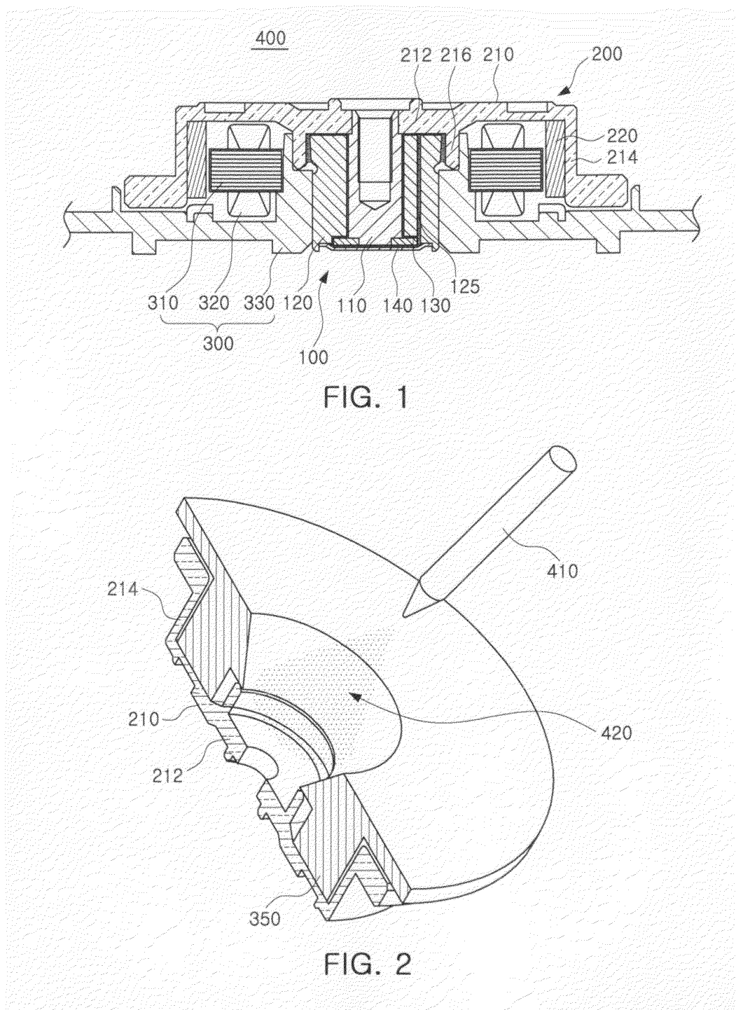

FIG. 1 is a schematic cross-sectional view showing a motor including a hydrodynamic bearing assembly according to a first exemplary embodiment of the present invention.

Referring to FIG. 1, a motor 400 including a hydrodynamic bearing assembly 100 according to the first exemplary embodiment of the present invention includes a hydrodynamic bearing assembly 100 including a rotary member 200 and a stator 300 including a core 310 on which a coil is wound.

Hereinafter, the configuration thereof will be described in detail.

The hydrodynamic bearing assembly 100 may include a shaft 110, a sleeve 120, a thrust plate 130, and the rotary member 200.

First, terms associated with directions are defined as follows: an axial direction refers to a vertical direction on the basis of the shaft 110, an outer radial direction or an inner radial direction refers to a direction towards an outer edge of the rotary member 200 on the basis of the shaft 110 or a central direction of the shaft 110 on the basis of the outer edge of the rotary member 200, as shown in FIGS. 1 to 8.

The sleeve 120 may support the shaft 110 so that the upper end of the shaft 110 protrudes upwardly in the axial direction and may be formed by forging Cu or Al or sintering a Cu—Fe based alloy powder or SUS based powder.

Herein, the shaft 110 is inserted into a shaft hole of the sleeve 120 having a minute gap therebetween and the minute gap is filled with oil. A radial dynamic pressure groove formed in at least one of the outer diameter of the shaft 110 and the inner diameter of the sleeve 120 may support the rotation of the rotary member 200 more smoothly.

The radial dynamic pressure groove may be formed in the inner surface of the sleeve 120, which is the inside of the shaft hole of the sleeve 120, and may generate pressure permitting the shaft 110 to be inclined in a certain direction when the shaft 110 is rotated.

However, the position of the radial dynamic pressure groove is not limited to the inner surface of the sleeve 120 as described above. The radial dynamic pressure groove may be provided on the outer diameter portion of the shaft 110. Also, the number of radial dynamic pressure grooves is not particularly limited.

A bypass channel 125 which allows the upper and lower portions of the sleeve 120 to be in communication with each other is provided in the sleeve 120 to keep an oil pressure in the hydrodynamic bearing assembly 100 to be balanced by dispersing the oil pressure and discharge bubbles in the hydrodynamic bearing assembly 100 by circulation.

Further, oil is sealed between the upper portion of the outer surface of the sleeve 120 and a wall portion 216 of the rotary member 200 to be described below. In other words, a gap therebetween may be widened downwardly in the axial direction in order to prevent the oil from being leaked to the outside while the motor is driven.

To enable this, the outer circumferential surface of the sleeve 120 corresponding to the wall portion 216 may be tapered in the inner radial direction.

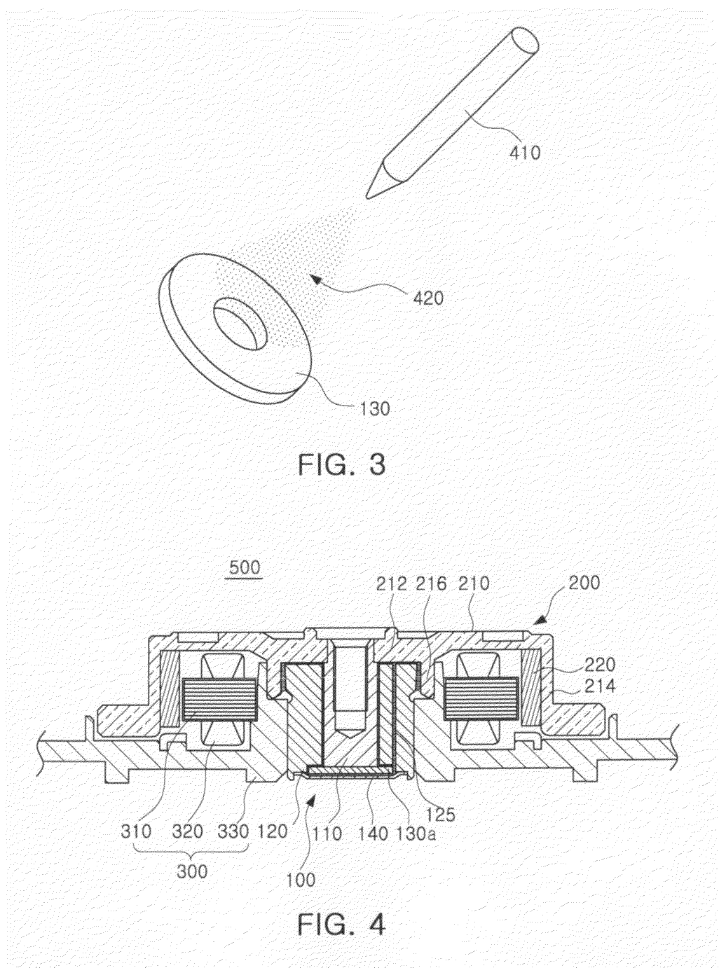

Herein, a coating film may be formed on the upper surface of the sleeve 120 by spraying a solid lubricant 420 (see FIGS. 2 and 3) having a single component thereon at high pressure. The coating film may reduce friction between the sleeve 120 and the rotary member 200 to be described below and increase the surface strength of the sleeve 120.

The principle and effect of spraying the solid lubricant 420 (see FIGS. 2 and 3) having a single component at high pressure will be described in detail with reference to FIGS. 2 and 3.

The thrust plate 130 is positioned in the lower portion of the sleeve 120 in the axial direction to be coupled to the shaft 110.

That is, the thrust plate 130 may be coupled to the shaft 110 to rotate simultaneously with the shaft 110, and may generate a thrust dynamic pressure when the motor 400 is driven.

The thrust plate 130 may have a hole at the center thereof. The hole corresponds to the section of the shaft 110, and the shaft 110 may be inserted into the hole.

Further, a thrust dynamic pressure groove generating a thrust dynamic pressure may be formed in at least one of the upper and lower surfaces of the thrust plate 130. The thrust dynamic pressure groove may have any one of a herringbone shape, a spiral shape, and a helical shape.

Further, a coating film may be formed on at least one of the upper and lower surfaces of the thrust plate 130 by spraying the solid lubricant 420 (see FIGS. 2 and 3) having the single component thereon at high pressure, like the upper surface of the sleeve 120. The coating film may reduce friction between the bottom surface of the sleeve 120 and the cover plate 140 to be described below and increase the surface strength of the thrust plate 130.

The principle and effect of spraying the solid lubricant 420 (see FIGS. 2 and 3) having a single component at high pressure will be described in detail with reference to FIGS. 2 and 3.

Herein, a cover plate is coupled to the sleeve 120 while maintaining a gap therebetween under the thrust plate 130, and the gap receives oil.

The gap between the cover plate 140 and the sleeve 120 is filled with oil, thereby serving as a bearing supporting the shaft 110 and the lower surface of the thrust plate 130.

The rotary member 200 is a rotary structure provided rotatably with respect to the stator 300 to be described below. The rotary member 200 may include a rotor case 210 having a ring-shaped magnet 220 corresponding to the core 310 with a predetermined gap therebetween along the inner circumferential surface thereof.

In other words, the rotor case 210 may be one component of the rotary member 200 which is press-fitted in the shaft 110 to be rotated in linkage with the shaft 110.

Herein, the magnet 220 may be a permanent magnet having north and south poles alternately arranged in a circumferential direction to generate a magnetic force having a predetermined intensity.

Further, the rotor case 210 may include a hub base 212 press-fitted into the upper end of the shaft 110 to be fixed thereto and a magnet supporting portion 214 extended from the hub base 212 in the outer diameter direction thereof and bent downwardly in the axial direction to support the magnet 220.

Further, the rotor case 210 may include the wall portion 216 allowing oil to be sealed between the wall portion 216 and the upper portion of the outer circumferential surface of the sleeve 120.

The gap between the wall portion 216 and the sleeve 120 may be gradually widened downwardly in the axial direction in order to prevent the oil from being leaked to the outside while the motor is driven.

Herein, a coating film may be formed on the inner surface of the rotor case 210 by spraying the solid lubricant 420 (see FIGS. 2 and 3) having a single component thereon at high pressure, like the thrust plate 130 and the upper surface of the sleeve 120, and the coating film may reduce friction with the upper surface of the sleeve 120 and increase the surface strength of the inner surface of the rotor case 210.

The principle and effect of spraying the solid lubricant 420 (see FIGS. 2 and 3) having a single component at high pressure will be described in detail with reference to FIGS. 2 and 3.

The stator 300 may include a coil 320, the core 310, and a base member 330.

In other words, the stator 300 may be the stationary structure that includes the coil 320 generating electromagnetic force having a predetermined magnitude when power is applied thereto and a plurality of cores 310 on which the coil 320 is wound.

The cores are fixedly disposed on the upper portion of the base member 330 having a printed circuit board (not shown) on which a circuit pattern is printed. A plurality of coil holes having a predetermined size may penetrate on the upper surface of the base member 330 corresponding to the winding coil 320 to allow the winding coil 320 to be exposed downwardly. The winding coil 320 may be electrically connected to the printed circuit board (not shown) to supply external power thereto.

The outer circumferential surface of the sleeve 120 may be press-fitted into the base member 330. The core 310 on which the coil 320 is wound may be inserted into the base member 330. The base member 330 may be assembled with the sleeve 120 by applying an adhesive to the inner surface of the base member 330 or the outer surface of the sleeve 120.

FIG. 2 is a schematic cut-away perspective view showing a case in which a solid lubricant is sprayed onto a surface of a rotor case at high pressure, the rotor case provided to the hydrodynamic bearing assembly according to the first exemplary embodiment of the present invention, and FIG. 3 is a schematic perspective view showing a case in which a solid lubricant is sprayed onto a thrust plate at high pressure, the thrust plate provided to the hydrodynamic bearing assembly according to the first exemplary embodiment of the present invention.

Referring to FIG. 2, the rotor case 210 of the rotary member 200 provided to the hydrodynamic bearing assembly 100 according to the first exemplary embodiment of the present invention is fixedly coupled to a fixation jig 350 as a single item before the motor 400 is assembled, and a coating film may be formed on the surface of the rotor case in contact with the upper surface of the sleeve 120 while the motor 400 is driven, by spraying the solid lubricant 420 having a single component thereon at high pressure.

The solid lubricant 420 in the form of powder particles having an ultrafine size may be sprayed on one surface of the rotor case by a high-pressure spraying member 410.

The particles having the ultrafine size are sprayed on one surface of the rotor case 210 at high speed by using the high-pressure spraying member 410 to improve strength and durability.

This is not a method of coating one surface of the rotor case 210, but the method of spraying the solid lubricant 420 of the ultrafine particles on one surface of the rotor case 210. Microdimples may be formed in one surface of the rotor case 210 due to impacts caused by the sprayed ultrafine particles and the microdimples may serve as an oil storage space positioned between the sleeve 120 and the rotor case 210, i.e., a reservoir.

Herein, the microdimples have different sizes depending on the types of the solid lubricant 420, but may have a diameter of approximately 11 μm when the solid lubricant 420 is molybdenum disulfide.

Accordingly, due to the oil stored in the microdimples, lubricity can be improved while the rotor case 210 rotates and abrasion resistance can be improved by minimizing rotary friction.

Further, the improvement of the abrasion resistance can ensure the driving stability of the motor 400 according to the exemplary embodiment of the present invention, and as a result, the lifespan thereof may be maximized.

Herein, the solid lubricant 420 may have a single component of at least one of a fluorine resin, graphite, and molybdenum disulfide. In the case in which the solid lubricant 420 is sprayed at high pressure, the rotor case 210 is coupled to the solid lubricant 420. As the solid lubricant 420 infiltrates the rotor case 210 and moves inwards, the content thereof may decrease.

The single-component and ultrafine-particle solid lubricant 420 is sprayed on one surface of the rotor case 210 at a very high speed and compression stress is generated at an impact point and a minute thermal reaction occurs.

Further, since the solid lubricant 420 is ultrafine power particles, the ultrafine particles easily infiltrate the surface of the rotor case 210 having a minute curvature which is difficult to observe, and since compression stress is generated, the strength of the rotor case 210 is improved.

The ultrafine particles of the solid lubricant 420, sprayed by the high-pressure spraying member 410, may have a micro-unit size as the ultrafine size and the spraying speed of the solid lubricant 420 may be substantially close to the speed of sound.

That is, the solid lubricant 420 may be ultrafine particles, e.g., 200 μm or less and the spraying pressure of the high-pressure spraying member 410 depends on the material of the solid lubricant 420, but may be generally 1 MPa or less.

Herein, the solid lubricant 420 is coupled to the surface of the rotor case 210, and after the coupling thereof, the size of the rotor case 210 remains substantially the same.

Although the size is changed on the level of a micro-unit or less, such a change in size does not affect the driving of the motor 400, and as a result, a processing operation for precisely adjusting the size of the rotor case 210 is not required after the solid lubricant 420 is sprayed at high pressure.

Accordingly, since the processing operation is not required, no portion to be discarded due to the processing operation is generated, such that the process may be economical.

Referring to FIG. 3, the solid lubricant 420 having a single component may be sprayed on at least one of the upper and lower surfaces of the thrust plate 130 provided to the hydrodynamic bearing assembly 100 according to the first exemplary embodiment of the present invention.

Herein, the solid lubricant 420 which is sprayed at high pressure may have the same configuration and effect as those of the solid lubricant 420 sprayed on one surface of the rotor case 210.

That is, the ultrafine-particle single-component solid lubricant 420 collides with one surface of the thrust plate 130 at a speed substantially close to the speed of sound by the high-pressure spraying member 410, such that compression stress is generated at an impact point and a minute thermal reaction occurs.

Therefore, the strength of the thrust plate 130 is improved, and lubricity and abrasion resistance are increased.

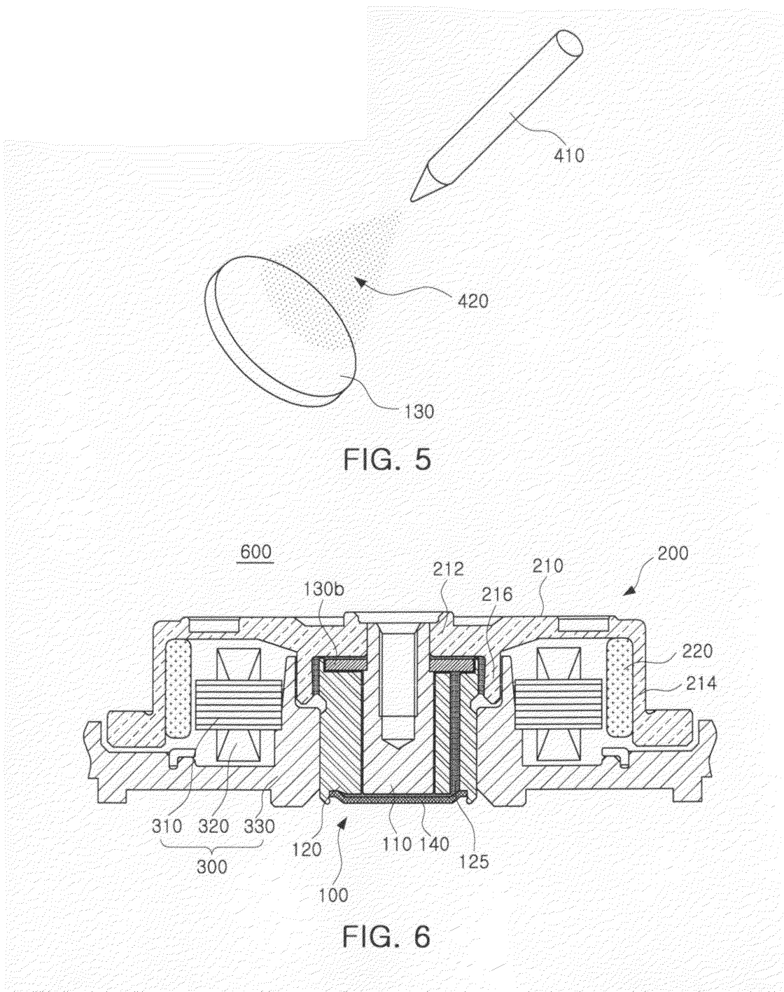

FIG. 4 is a schematic cross-sectional view showing a motor including a hydrodynamic bearing assembly according to a second exemplary embodiment of the present invention, and FIG. 5 is a schematic perspective view showing a case in which a solid lubricant is sprayed on a thrust plate at high pressure, the thrust plate provided to the hydrodynamic bearing assembly according to the second exemplary embodiment of the present invention.

Referring to FIGS. 4 and 5, since a motor 500 including the hydrodynamic bearing assembly 100 according to the second exemplary embodiment of the present invention has the same configuration and effect as those of the first exemplary embodiment of the present invention, except for a thrust plate 130a, a detailed description thereof other than the thrust plate 130a will be omitted.

The thrust plate 130a is not fixedly inserted into the shaft 110, but may be coupled to the lower surface of the shaft 110.

The solid lubricant 420 having a single component may be sprayed on at least one of a portion of the upper surface of the thrust plate 130a, protruding outwardly of the shaft 110, and the lower surface of the thrust plate 130a at high pressure.

Herein, the solid lubricant 420 which is sprayed at high pressure may have the same configuration and effect as those of the solid lubricant 420 sprayed on one surface of the rotor case 210 or the thrust plate 130 as described in the first exemplary embodiment.

That is, the ultrafine-particle single-component solid lubricant 420 collides with one surface of the thrust plate 130a at a speed substantially close to the speed of sound by the high-pressure spraying member 410, such that compression stress is generated at an impact point and a minute thermal reaction occurs.

Therefore, the strength of the thrust plate 130a is improved, and lubricity and abrasion resistance are increased.

FIG. 6 is a schematic cross-sectional view showing a motor including a hydrodynamic bearing assembly according to a third exemplary embodiment of the present invention.

Referring to FIG. 6, since a motor 600 including the hydrodynamic bearing assembly 100 according to the third exemplary embodiment of the present invention has the same configuration and effect as those of the first exemplary embodiment of the present invention, except for the layout of a thrust plate 130b, a detailed description thereof other than the thrust plate 130b will be omitted.

The thrust plate 130 is positioned at the upper portion of the sleeve 120 in the axial direction to be coupled to the shaft 110.

The thrust plate 130b may have a hole at the center thereof. The hole corresponds to the section of the shaft 110 and the shaft 110 may be inserted into the hole.

Further, a thrust dynamic pressure groove generating a thrust dynamic pressure may be formed in at least one of the upper and lower surfaces of the thrust plate 130b. The thrust dynamic pressure groove may have anyone of a herringbone shape, a spiral shape, and a helical shape.

The ultrafine-particle single-component solid lubricant 420 is sprayed on at least one of the upper and lower surfaces of the thrust plate 130b at a speed close to the speed of sound at high pressure to thereby improve the strength of the thrust plate 130b and increase lubricity and abrasion resistance.

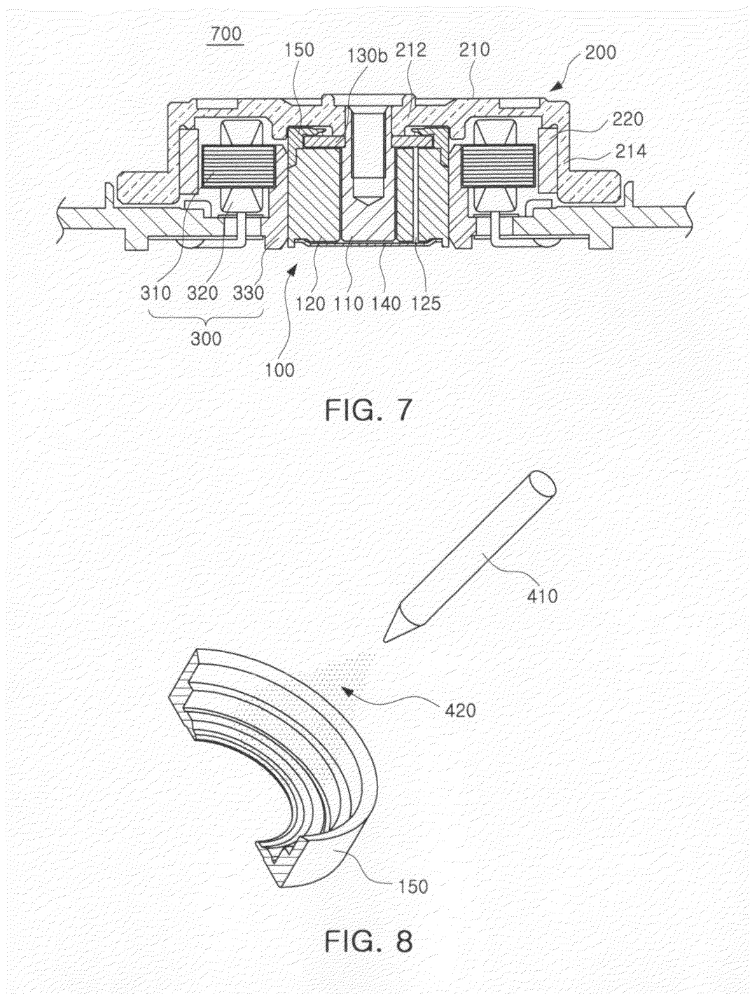

FIG. 7 is a schematic cross-sectional view showing a motor including a hydrodynamic bearing assembly according to a fourth exemplary embodiment of the present invention, and FIG. 8 is a schematic cut-away perspective view showing a case in which a solid lubricant is sprayed on a cap member at high pressure, the cap member provided to the hydrodynamic bearing assembly according to the fourth exemplary embodiment of the present invention.

Referring to FIGS. 7 and 8, since a motor 700 including the hydrodynamic bearing assembly 100 according to the fourth exemplary embodiment of the present invention has the same configuration and effect as those of the third exemplary embodiment of the present invention, except for a cap member 150, a detailed description thereof other than the cap member 150 will be omitted.

The cap member 150 is press-fitted around the upper portion of the thrust plate 130b to allow oil to be sealed between the cap member 150 and the thrust plate 130b. The cap member 150 has a groove to allow the thrust plate 130b and the sleeve 120 to be press-fitted.

The cap member 150 may have a protrusion formed on the lower surface thereof to seal the oil and use a capillary action and the surface tension of the oil in order to prevent the oil from being leaked to the outside while the motor is driven.

Herein, since the oil is sealed by the cap member 150, the wall portion 216 provided in the rotor case 210 in the first to third exemplary embodiments may not be an indispensable component.

Further, the ultrafine-particle single-component solid lubricant 420 is sprayed on at least one of the upper surface of the sleeve 120 corresponding to the lower surface of the thrust plate 130b, the upper or lower surface of the thrust plate 130b, and one surface of the cap member 150 corresponding to the upper surface of the thrust plate 130b at a speed close to the speed of sound at high pressure to thereby improve the strength of the thrust plate 130b or the cap member 150 and increase lubricity and abrasion resistance.

In the motor 400, 500, 600, and 700 including the hydrodynamic bearing assembly 100 according to the exemplary embodiments of the present invention, a coating film is formed by spraying the solid lubricant 420 having a single component on at least one of the sleeve 120 and one surface of the rotor case 210 corresponding to the sleeve 120 at high pressure, thereby minimizing friction between the sleeve 120 and the rotor case 210, and maximizing lubricity and durability therebetween.

Further, a coating film may be formed by spraying the solid lubricant 420 having a single component on one surface of the thrust plate 130, 130a, or 130b or the cap member 150 at high pressure so as to acquire the same effect.

In addition, since the spraying is not accompanied by a change in size, the additional processing operation is not required, and as a result, the amount of portions to be discarded can be minimized.

As set forth above, by a hydrodynamic bearing assembly and a motor including the same according to exemplary embodiments of the present invention, lubricity and abrasion resistance are improved to thereby increase the stability and lifespan thereof.

Further, since a processing operation for a friction portion is not required, a process is simplified and the loss of a portion to be discarded depending on the processing operation can be minimized.

While the present invention has been shown and described in connection with the exemplary embodiments, it will be apparent to those skilled in the art that modifications and variations can be made without departing from the spirit and scope of the invention as defined by the appended claims.

What is claimed is:

1. A hydrodynamic bearing assembly comprising:
a rotary member fixed to a shaft and rotating in linkage with the shaft; and
a sleeve supporting the shaft,
wherein a coating film is formed by spraying, at high pressure, a solid lubricant having a single component onto one surface of at least one of the sleeve and the rotary member corresponding to the sleeve.

2. The hydrodynamic bearing assembly of claim 1, wherein the solid lubricant is formed of particles having an ultrafine size.

3. The hydrodynamic bearing assembly of claim 1, wherein a microdimple is formed in one surface of the sleeve or of the rotary member corresponding to the sleeve onto which the solid lubricant is sprayed at high pressure.

4. The hydrodynamic bearing assembly of claim 3, wherein the microdimple is an oil storage space positioned between the sleeve and the rotary member.

5. The hydrodynamic bearing assembly of claim 1, wherein the solid lubricant is at least one of a fluorine resin, graphite, and molybdenum disulfide.

6. The hydrodynamic bearing assembly of claim 1, wherein the sleeve or the rotary member corresponding to the sleeve, onto which the solid lubricant is sprayed at high pressure, is coupled to the solid lubricant, and as the solid lubricant infiltrates and moves inwards, a content thereof decreases.

7. A hydrodynamic bearing assembly comprising:
a rotary member fixed to a shaft and rotating in linkage with the shaft;
a sleeve supporting the shaft; and
a thrust plate disposed in at least one of upper and lower portions of the shaft in an axial direction thereof, coupled to the shaft, and providing thrust dynamic pressure,
wherein a coating film is formed by spraying, at high pressure, a solid lubricant having a single component onto one surface of at least one of the thrust plate, the sleeve and the rotary member corresponding to the thrust plate.

8. The hydrodynamic bearing assembly of claim 7, wherein the solid lubricant is formed of particles having an ultrafine size.

9. The hydrodynamic bearing assembly of claim 7, wherein a microdimple is formed in one surface of the sleeve or of the rotary member corresponding to the sleeve, onto which the solid lubricant is sprayed at high pressure.

10. The hydrodynamic bearing assembly of claim 9, wherein the microdimple is an oil storage space positioned between the sleeve and the rotary member.

11. The hydrodynamic bearing assembly of claim 7, wherein the solid lubricant is at least one of a fluorine resin, graphite, and molybdenum disulfide.

12. The hydrodynamic bearing assembly of claim 7, wherein the sleeve or the rotary member corresponding to the sleeve, onto which the solid lubricant is sprayed at high pressure, is coupled to the solid lubricant, and as the solid lubricant infiltrates and moves inwards, a content thereof decreases.

13. The hydrodynamic bearing assembly of claim 7, further comprising a cap member coupled to the sleeve on an upper portion of the thrust plate such that oil is sealed between the thrust plate and the cap member,
wherein the thrust plate is positioned on the upper portion of the shaft in the axial direction thereof.

14. The hydrodynamic bearing assembly of claim 13, wherein a coating film is formed on one surface of the cap member corresponding to the thrust plate by spraying a solid lubricant having a single component thereon at high pressure.

15. A motor comprising:
the hydrodynamic bearing assembly according to claim 1; and
a stator coupled to an outer circumferential surface of the sleeve and including a core on which a coil for generating a rotational driving force due to interaction with a magnet coupled to one surface of the rotary member is wound.

16. A motor comprising:
the hydrodynamic bearing assembly according to claim 7; and
a stator coupled to an outer circumferential surface of the sleeve and including a core on which a coil for generating a rotational driving force due to interaction with a magnet coupled to one surface of the rotary member is wound.
